(19) United States
(12) Patent Application Publication
(10) Pub. No.: US 2007/0128355 A1
(43) Pub. Date: Jun. 7, 2007

(54) Method for coating photoresist material

(75) Inventor: Hun Rok Jung, Icheon-si (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hynix Semiconductor, Inc., Icheon-si (KR)

(21) Appl. No.: 11/482,136

(22) Filed: Jul. 5, 2006

(30) Foreign Application Priority Data
Dec. 6, 2005 (KR) 10-2005-0118045

(51) Int. Cl. B05D 3/12

(52) U.S. Cl. 427/240; 427/346

(57) ABSTRACT

A method for coating photoresist material comprises loading a substrate onto a spin chuck in a spin coater. Thinner is injected onto the substrate being in rest during a first period of time. The substrate is spun with a first speed for a second period of time less than the first period of time to spread the injected thinner onto the substrate. Photoresist material is injected onto the substrate spinning with a second speed faster than the first speed to coat the photoresist material thereon. The substrate is decelerated to a third speed slower than the first speed to stabilize the coated photoresist material.

### CROSS-REFERENCES TO RELATED APPLICATIONS

The present application claims priority to Korean patent application number 10-2005-0118045, filed on Dec. 6, 2005, which is incorporated by reference in its entirety.

### BACKGROUND OF THE INVENTION

The present invention relates to a lithography technology.

Photolithography process is a process to form an image onto a coated photoresist material over a substrate having an etching layer by transmitting a light through lenses in a lithography apparatus and through an original pattern of “a mask”; to form a reduced photoresist material pattern over the substrate, according to the original pattern by selectively removing the photoresist material according to photosensitivity (that is, a portion of the photoresist material exposed to light); and to form an etching layer pattern by etching the etching layer using the photoresist material pattern as an etching mask.

Here, the following is a method for coating a photoresist material located over a substrate. First, in a static coating method, a photoresist material is dispensed onto a substrate being in rest, and then the substrate is highly spun to coat the photoresist material.

In addition, there is a coating method in which the photoresist material is dispensed onto the highly spinning substrate. Further, there is a coating method in which the photoresist material is dispensed onto the substrate being in rest, and the photoresist material is dispensed onto the substrate while the substrate is highly spun.

According to the above coating method, when an amount of the photoresist material is at least less than 3 cc, the photoresist material is not uniformly coated onto the substrate due to viscosity of the photoresist material. The photoresist material is split at the edge of the substrate because of slight step difference of the resulting structure on the substrate.

In order to solve the above problems, solvent used as thinner, which is a similar type for the photoresist material, is dispensed onto a substrate. The photoresist material is then dispensed onto the spinning substrate, thereby uniformly coating the substrate with a small amount of the photoresist material.

FIGS. 1a through 1d are simplified cross-sectional views illustrating a conventional method for coating a photoresist material, which refers to a Reducing resist consumption (RRC) method. Referring to FIG. 1a, a substrate 30 is loaded onto a spin chuck 20 of a spin coater 10. Thinner nozzle 35 is located over a center of the substrate 30 being in rest. Thinner 40 is dispensed onto the substrate 10.

Referring to FIG. 1b, the substrate 30 is spun with a low revolution per minute (RPM) while a photoresist nozzle 45 is moved to the center of the substrate 30. As a result, the thinner 40 is uniformly spread onto the substrate 30.

Referring to FIGS. 1c and 1d, the photoresist material 50 is dispensed onto the substrate 30 while the substrate 30 is spinning with a relatively high RPM, to coat the photoresist material 50 with a uniform thickness over the substrate 30. The substrate 30 is decelerated to stabilize the coated photoresist material 50.

TABLE 1

| | | Rotational | | |
|---|---|---|---|---|
| | Time | speed | | |
| Step | (Sec) | (Rpm) | Dispense | Arm 1 |
| 1 | 1.0 | 0 | | Dispn 1 |
| | | | | 150 mm/s W |
| 2 | 1.0 | 0 | Thinner | Dispn 1 |
| | | | | 150 mm/s NW |
| 3 | 1.0 | 2000 | | Center |
| | | | | 150 mm/s NW |
| 4 | 1.2 | 4000 | Photoresist | Center |
| | | | | 150 mm/s NW |
| 5 | 1.0 | 2000 | | Home |
| | | | | 100 mm/s NW |
| 6 | 25.0 | **** | | Home |
| | | | | 100 mm/s NW |

Table 1 shows a conventional recipe of a spin coater. Referring to Table 1, a thinner nozzle is moved to “Dispn 1” for one second in order to dispense a thinner. Here, “Dispn 1” is a location of the dispense nozzle, which is separated from the center of a substrate by a distance ranging from 1 to 5 cm. The thinner is dispensed onto the substrate for one second. While a photoresist nozzle is moved to the center of the substrate, the substrate is spun with 2000 RPM for one second to enable the dispensed thinner to uniformly spread onto the substrate. While a photoresist material is dispensed for 1.2 seconds, the substrate is accelerated to 4000 RPM to coat the dispensed photoresist material onto the substrate. The substrate is decelerated to 2000 RPM for one second to stabilize the coated photoresist material. In Table 1, Wait (W) of Arm 1 column requires the next process to halt until the dispense nozzle is placed where it is to be if the nozzle is not placed for a certain time. Non-wait (NW) of Arm 1 column means a material to be dispensed even if the dispense nozzle is not placed where it is to be.

According to the above conventional method for coating a photoresist material, the photoresist material is dispensed after the thinner is spread onto the substrate. The substrate is spun with a relatively high speed for spreading the thinner onto the substrate after the thinner is dispensed onto the substrate being in rest. Due to high volatility of the thinner, volatilizing the thinner is accelerated. As a result of volatilizing the thinner, there is a problem of increasing the dispensed amount of the photoresist material.

### BRIEF SUMMARY OF THE INVENTION

Embodiments of the present invention are directed to a method for coating photoresist material with use of a minimum amount of the photoresist material during the process.

According to an embodiment of the present invention, a method for coating a photoresist material includes: loading a substrate onto a spin chuck in a spin coater; injecting thinner onto the substrate being in rest during a first period of time; spinning the substrate with a first speed for a second period of time less than the first period of time to spread the injected thinner onto the substrate; injecting photoresist material onto the substrate spinning with a second speed faster than the first speed to coat the photoresist material thereon; and decelerating the substrate to a third speed slower than the first speed to stabilize the coated photoresist material.

In one embodiment of the present invention, a thickness of the photoresist material coated onto the substrate is proportional to the number of substrate rotations per unit time. The thickness of the coated photoresist material is determined by the following equation with factors such as centrifugal force and viscosity of the photoresist material:

$$Hm = K \times {[ \frac{σ ( 1 - cos θ )}{ρ} ]}^{1 / 5} \times {[ \frac{υ}{r {ω}^{2}} ]}^{2 / 5} ,$$

where Hm is a height proportional to minimum resist volume,

K is a coefficient of the spin coater,

σ is surface tension of the photoresist material,

θ is a contact angle between the photoresist material and the thinner,

ρ is density of the photoresist material,

υ is viscosity of the photoresist material, and

rω² is centrifugal force.

### BRIEF DESCRIPTION OF THE DRAWINGS

FIGS. 1a through 1d are simplified cross-sectional views illustrating a conventional method for coating a photoresist material.

FIG. 2 is a simplified conceptual view illustrating a method for coating a photoresist material according to an embodiment of the present invention.

FIGS. 3a through 3d are simplified cross-sectional views illustrating a method for coating a photoresist material according to an embodiment of the present invention.

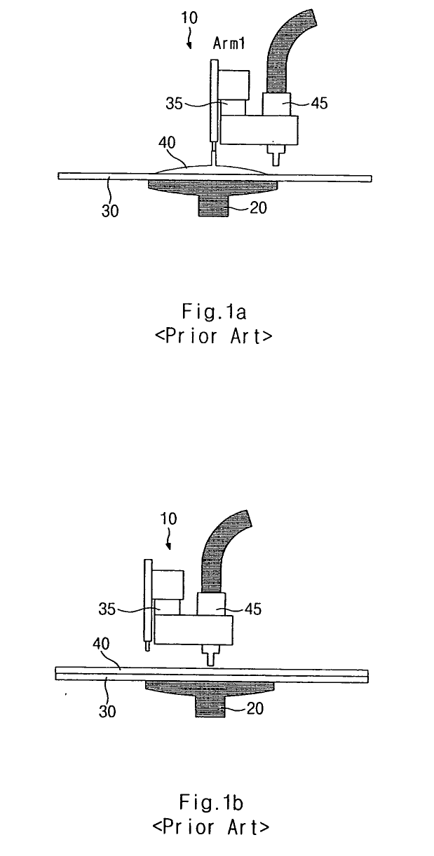

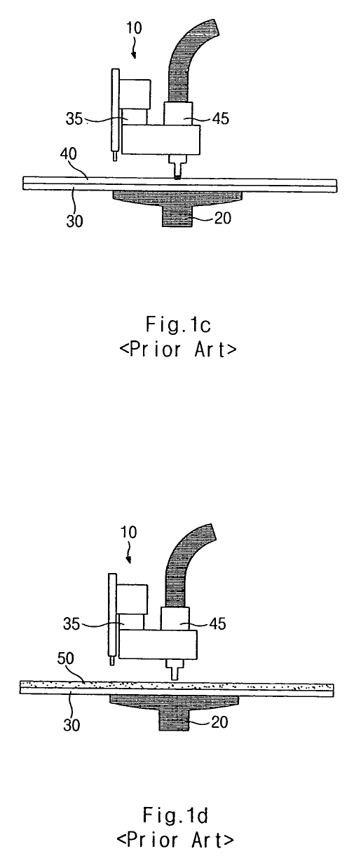

Table 1 shows a conventional recipe of a spin coater.

Table 2 shows a recipe of a spin coater according to an embodiment of the present invention.

Table 3 shows a recipe of a system according to an embodiment of the present invention.

Table 4 shows a thickness result of a coated photoresist material according to an embodiment of the present invention.

### DESCRIPTION OF SPECIFIC EMBODIMENT

The present invention relates to a method for coating photoresist material. After thinner is dispensed onto a substrate being in rest, photoresist material is dispensed onto the dispensed thinner. At the substantially same time, the substrate is spinning to coat the photoresist material thereon. After coating the photoresist material, the rotational speed of the substrate is sharply decelerated to stabilize the coated photoresist material. In accordance with an embodiment of the present invention, a desired thickness of the photoresist material is obtained while a minimum amount of the photoresist material is used. Accordingly, the cost and yield of the process can be improved.

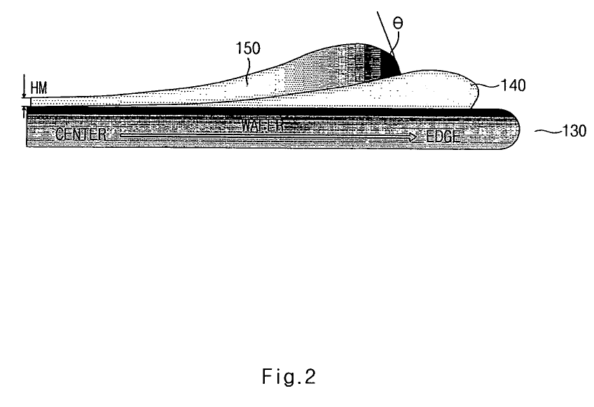

FIG. 2 a simplified conceptual view illustrating a principal of dispensing thinner and photoresist material according to an embodiment of the present invention. Referring to FIG. 2, the photoresist material 150 has its thickness Hm and a contact angle θ between the photoresist material 150 and the thinner 140 during a process for coating the thinner 140 and the photoresist material 150 over a substrate 130.

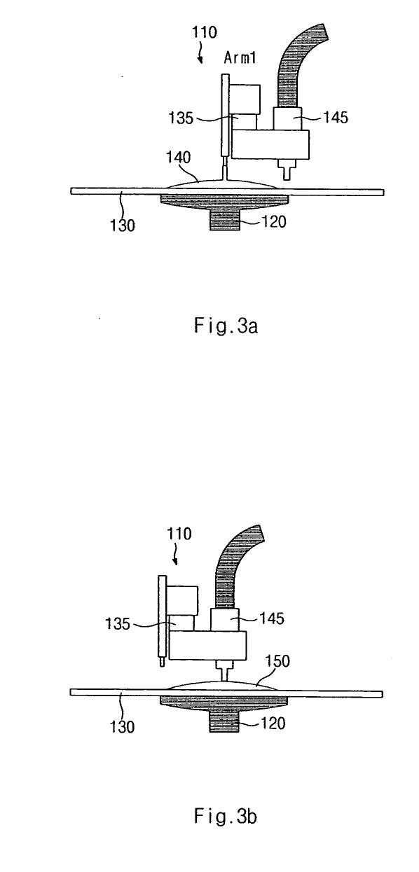

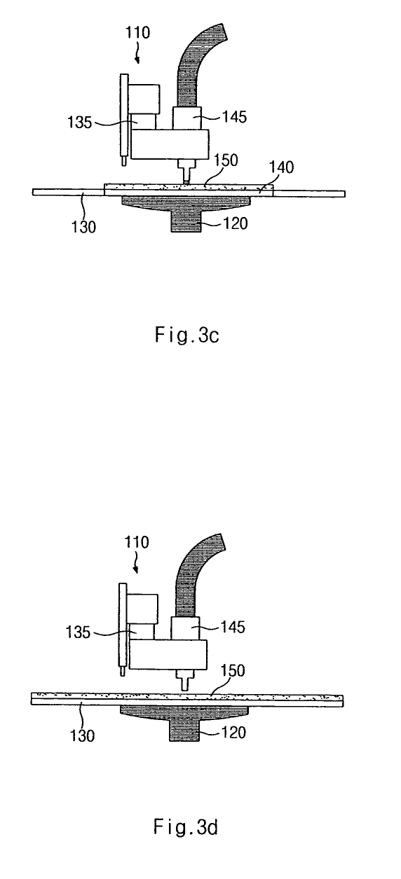

FIGS. 3a through 3d are simplified cross-sectional views illustrating a method for coating a photoresist material according to an embodiment of the present invention, which refers to a dynamic Reducing resist consumption (RRC) method. Referring to FIG. 3a, a substrate 130 is loaded onto a spin chuck 120 of a spin coater 110. A thinner nozzle 135 filled with solvent is located over a center of the substrate 130 being in rest for a predetermined period of time ranging from about 0.5 to 3 seconds. Thinner 140 is dispensed onto the substrate 130. Here, if the thinner nozzle 135 is not placed over the substrate 130 for the predetermined period of time, the next process is delayed until the thinner nozzle 135 is placed over the substrate 130.

Referring to FIGS. 3b through 3d, the dispensed thinner 140 is slowly spread while a photoresist nozzle 145 is moved over the center of the substrate 130 for a predetermined period of time ranging from about 0.5 to 3 seconds. The substrate is spun with a low rotational speed ranging from about 1000 to 2500 RPM for a predetermined period of time ranging from about 0.1 to 1 second to spread the thinner 140 onto the substrate 130. Photoresist material 150 is dispensed over the thinner 140 for a predetermined period of time ranging from about 1.0 to 3 seconds. At the substantially same time, the rotational speed of the substrate 130 is accelerated to coat the photoresist material 150 onto the substrate 130, wherein the rotational speed of the substrate 130 ranges from about 2000 to 5000 RPM. The rotational speed of the substrate 130 is decelerated to stabilize the coated photoresist material 150 for a predetermined period of time ranging from about 1.0 to 3 seconds, wherein the rotational speed of the substrate 130 ranges from about 100 to 300 RPM.

In one embodiment of the present invention, a temperature of the photoresist material 150 ranges from about 22° C. to about 23° C. In addition, the photoresist material 150 is dissolved in the thinner 140 of about 70-80% (V/V). The dispensed amount of the photoresist material 150 ranges from about 0.1 to 1.5 mL.

According to the dynamic RRC method of the present invention, the thinner and the photoresist material onto the substrate coated with a hexamethyldisilazane (HMDS) solution have hydrophobicity, which results in decreasing the contact angle θ between the thinner and the photoresist material. Since the substrate is spun in the mixture of the thinner and the photoresist material in order to dispense the photoresist material, centrifugal force rω² is relatively increased. As a result, the photoresist material can be coated with a consumed amount of the photoresist material at most less than 0.5 cc. Accordingly, a thickness Hm of the photoresist material is reduced due to decreasing surface tension of the photoresist material over the substrate, which is resulted from a high speed RPM and a thinner spread timing.

In one embodiment of the present invention, the following is a precursor condition for coating the photoresist material.
1. Pump recipe: dispensed photoresist amount of 0.5 mL;
2. Coater recipe: referring to Table 2;
3. Chill plate recipe: plate temperature of 24° C.;
4. System recipe: referring to Table 3; and

5. Substrate flow: Start stage=>Transition=>Adhesion=>Chill plate=>Coater=>Hot plate with a low temperature=>Chill plate.

TABLE 2

| | | Rotational | | |
|---|---|---|---|---|
| | Time | speed | | |
| Step | (Sec) | (Rpm) | Dispense | Arm 1 |
| 1 | 1.0 | 0 | | Dispn 1 |
| | | | | 150 mm/s W |
| 2 | 1.0 | 0 | Thinner | Dispn 1 |
| | | | | 150 mm/s W |
| 3 | 1.0 | 0 | | Center |
| | | | | 150 mm/s NW |
| 4 | 0.1 | 1000 | | Center |
| | | | | 150 mm/s NW |
| 5 | 1.0 | 4000 | Photoresist | Center |
| | | | | 150 mm/s NW |
| 6 | 1.0 | 100 | | Center |
| | | | | 150 mm/s NW |
| 7 | 25.0 | **** | | Home |
| | | | | 100 mm/s NW |

Table 2 shows a recipe for a spin coater according to an embodiment of the present invention. Referring to Table 2, a thinner nozzle is moved to “Dispn 1” for one second in order to dispense a thinner. The thinner is dispensed onto the substrate being in rest for one second. A photoresist nozzle is moved to the center of the substrate for one second to slowly spread the dispensed thinner onto the substrate. The substrate is spinning to spread the thinner for 0.1 second with 1000 RPM. Here 0.1 second is relatively a short period of time compared to that of the conventional method for coating photoresist material (i.e. 1 second). In one embodiment of the present invention, the rotational speed of the substrate is slower than that of the conventional method for coating photoresist material (i.e. 2000 RPM). Photoresist material is dispensed for one second. At the substantially same time, the rotational speed of the substrate is accelerated to 4000 RPM to coat the dispensed photoresist material onto the substrate. The rotational speed of the substrate is decelerated to 100 RPM to stabilize the coated photoresist material for one second. The substrate is spinning with an arbitrary rotational speed for 25 seconds to control a thickness of the coated photoresist material while the nozzle is move to “Home.” Here, “Home” is a waiting location for the dispense nozzle, which is separated from the edge of the substrate by a predetermined distance.

Table 3 shows a recipe for a system according to an embodiment of the present invention.

TABLE 3

| | Module | Module | | | Alm | Alm | Stop | Stop |
|---|---|---|---|---|---|---|---|---|
| No. | Name | No. | Control target | Set val | max | min | max | min |
| 1 | Coater | 2-1 | Resist Temp. | 22.0° C. | 0.3 | 0.3 | 0.5 | 0.5 |
| 2 | Coater | 2-1 | Cup humidity | 45.0% | 1.0 | 1.0 | 3.0 | 3.0 |
| 3 | Coater | 2-1 | Cup Temp. | 23.0° C. | 0.5 | 0.5 | 1.0 | 1.0 |
| 4 | Coater | 2-2 | Resist Temp. | 22.0° C. | 0.3 | 0.3 | 0.5 | 0.5 |
| 5 | Developer | 2-3 | Developer 1 Temp. | 23.0° C. | 0.3 | 0.3 | 0.5 | 0.5 |

Table 4 shows a thickness result of a coated photoresist material according to an embodiment of the present invention.

TABLE 4

| Nozzle | Target(Å) | Max(Å) | Min(Å) | Range(Å) | Mean(Å) |
|---|---|---|---|---|---|
| 1 | 2400 | 2398.41 | 2387.36 | 11.05 | 2393.59 |
| | | 2403.38 | 2390.72 | 12.66 | 2396.23 |
| | 2000 | 2010.52 | 2001.11 | 9.41 | 2006.45 |
| | | 2007.98 | 1994.22 | 13.76 | 2002.76 |
| 2 | 2000 | 2000.49 | 1992.60 | 7.89 | 1996.46 |
| | | 1999.87 | 1993.97 | 5.90 | 1996.63 |
| 3 | 3000 | 2913.95 | 2887.32 | 26.63 | 2903.10 |
| | | 2912.31 | 2886.49 | 25.82 | 2901.76 |
| | 2400 | 2320.45 | 2303.28 | 17.16 | 2313.59 |
| | | 2318.49 | 2300.68 | 17.81 | 2311.47 |
| | 4000 | 3874.77 | 3842.94 | 31.83 | 3860.66 |
| | | 3870.54 | 3842.64 | 28.90 | 3859.45 |
| 4 | 2000 | 2061.76 | 2046.01 | 15.75 | 2055.68 |
| | | 2061.82 | 2045.75 | 16.07 | 2055.50 |
| | 3000 | 3080.93 | 3059.84 | 21.08 | 3071.26 |
| | | 3079.74 | 3061.03 | 16.71 | 3070.71 |
| 5 | 410 | 418.32 | 409.89 | 8.43 | 414.26 |
| | | 417.89 | 408.58 | 9.31 | 414.62 |
| 6 | 410 | 408.33 | 403.35 | 4.98 | 405.91 |
| | | 407.60 | 404.47 | 3.13 | 406.08 |
| | 330 | 332.42 | 328.06 | 4.36 | 330.70 |
| | | 332.82 | 329.18 | 3.64 | 331.35 |

In addition, subsequent processes can be done by well known processes.

As described above, the method for coating a photoresist material in accordance with an embodiment of the present invention provides a photoresist film with a relative small thickness to employ the method for coating a photoresist material to a next generation immersion lithography process as well as the conventional lithography process. Accordingly, the cost of the lithography process can be reduced.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

What is claimed is:

1. A method for coating a photoresist material comprising:
loading a substrate onto a spin chuck in a spin coater;
injecting thinner onto the substrate being in rest during a first period of time;
spinning the substrate with a first speed for a second period of time shorter than the first period of time to spread the injected thinner onto the substrate;
injecting photoresist material onto the substrate spinning with a second speed faster than the first speed to coat the photoresist material thereon; and
decelerating the substrate to a third speed slower than the first speed to stabilize the coated photoresist material.

2. The method according to claim 1, wherein the first period of time ranges from about 1 to 3 seconds.

3. The method according to claim 1, wherein in the spinning-the-substrate step, the second period of time ranges from about 0.1 to 1 second, and the first speed ranges from about 1000 to 2500 RPM.

4. The method according to claim 1, wherein the second speed ranges from about 2000 to 5000 RPM.

5. The method according to claim 1, wherein the third speed ranges from about 100 to 300 RPM.

6. The method according to claim 1, further comprising moving a photoresist nozzle over the substrate being in rest for a predetermined period of time.

7. The method according to claim 6, wherein the predetermined period of time ranges from about 0.5 to 3 seconds.

8. The method according to claim 1, wherein a thickness of the coated photoresist material is determined by the following equation,
$$Hm = K \times {[ \frac{σ ( 1 - cos θ )}{ρ} ]}^{1 / 5} \times {[ \frac{υ}{r {ω}^{2}} ]}^{2 / 5} ,$$
where Hm is a height proportional to minimum resist volume,
K is a coefficient of the spin coater,
σ is surface tension of the photoresist material,
θ is a contact angle between the photoresist material and the thinner,
ρ is density of the photoresist material,
υ is viscosity of the photoresist material, and
rω² is centrifugal force.

9. The method according to claim 1, wherein a dispensed amount of the photoresist material ranges from about 0.1 to 1.5 mL.

10. The method according to claim 1, wherein a temperature of the photoresist material ranges from about 22 to 23° C.
